(19) United States
(12) Patent Application Publication
(10) Pub. No.: US 2019/0070831 A1
(43) Pub. Date: Mar. 7, 2019

(54) METHOD FOR MANUFACTURING A LAMINATED GLASS WITH AN INSERTED FILM

(71) Applicant: E-LEAD ELECTRONIC CO., LTD., CHANGHUA (TW)

(72) Inventor: Stephen CHEN, CHANGHUA (TW)

(73) Assignee: E-Lead Electronic Co., Ltd.

(21) Appl. No.: 15/695,656

(22) Filed: Sep. 5, 2017

(51) Int. Cl. B32B 17/10

(52) U.S. Cl. CPC B32B 17/10036; B32B 17/1055; B32B 17/10871; B32B 2329/06; B32B 17/10972; B32B 2250/05; B32B 2307/416; B32B 17/10899

(57) ABSTRACT

A method for manufacturing a laminated glass with an inserted film includes: forming a receiving hole in a first soft transparent plastic layer; placing the first soft transparent plastic layer on a first layer of glass; putting a soft transparent plastic sandwich containing the inserted film into the receiving hole, wherein the soft transparent plastic sandwich has a thickness equal to or smaller than a depth of the receiving hole; covering with a second layer of glass, and clamping the first layer of glass and the second layer of glass together with a tool; debubbling; and bonding with high temperature and pressure. The method is capable of inserting the film in a small area instead of in a large area of the laminated glass, so as to reduce the production cost.

### BACKGROUND

### Field of the Invention

The present invention relates to a laminated glass, and more particularly to a method for manufacturing a laminated glass with an inserted film.

Related Prior Art

As shown in FIG. 1A, a method for manufacturing a laminated glass includes: putting a soft transparent plastic (PVB) layer 12 on a first layer of glass 11, then putting a second layer of glass 13 on the soft transparent plastic layer 12. The three are clamped together and go through a first processing stage in which they are slightly heated under pressure to remove residual air bubbles, and then go through a second processing stage in which they are further heated at a higher temperature and under higher pressure, so that the first and second layers of glass 11, 13 are bonded to the soft transparent plastic layer 12.

To put a functional film at a specific position within the laminated glass, and if the film is directly disposed between the glass and the soft plastic, it will adversely affect the adhesion of the soft plastic to the glass, consequently affect the safety of the laminated glass. For example, as shown in FIG. 1B, a laminated glass with a functional film disclosed in Taiwan Patent No. M481234 essentially comprises two soft plastic layers 17 of the same thickness disposed between two layers of glass 16, and then a film 18 is inserted between the two soft plastic layers 17 to improve the safety of the laminated glass. However, in addition to increasing the risk of residual bubbles, the two laminated soft plastic layers 17 also affect the yield rate of the laminated glass. Besides, the laminated glass is often produced in large sizes, and as a result, the manufacturing cost will be relatively increased at such a low yield rate.

The present invention has arisen to mitigate and/or obviate the afore-described disadvantages.

### SUMMARY

One objective of the present invention is to provide a method for manufacturing a laminated glass with an inserted film capable of reducing production cost.

To achieve the above objective, a method for manufacturing a laminated glass with an inserted film provided by the invention comprises the followings steps:

a step A of forming a receiving hole in a first soft transparent plastic layer;

a step B of placing the first soft transparent plastic layer on a first layer of glass;

a step C of putting a soft transparent plastic sandwich containing the inserted film into the receiving hole, wherein the soft transparent plastic sandwich has a thickness equal to or smaller than a depth of the receiving hole;

a step D of covering with a second layer of glass, and clamping the first layer of glass and the second layer of glass together with a tool;

a step E debubbling; and

a step F bonding with high temperature and pressure.

Preferably, after the step B, the first soft transparent plastic layer is pulled flat and the receiving hole is adjusted to an appropriate position.

Preferably, the soft transparent plastic sandwich is formed by inserting the inserted film between two second soft transparent plastic layers.

Preferably, the two second soft transparent plastic layers are made of polyvinyl butyral.

Preferably, the inserted film is made of cyclic olefin polymer.

Preferably, the first soft transparent plastic layer is made of polyvinyl butyral.

Preferably, the inserted film is a reflection layer to provide a reflection surface.

The method for manufacturing a laminated glass with inserted films in accordance with the invention is capable of inserting the film in a small area instead of in a large area of the laminated glass, namely, the inserted film is firstly inserted in the small soft transparent plastic sandwich, so as to reduce the production cost. Meanwhile, the residual air bubbles which will influence the yield rate are processed in the soft transparent plastic sandwich, even if bubbles occur, the defective product will only be the soft transparent plastic sandwich instead of the whole laminated glass, so that the production cost is effectively reduced. Besides, the small size soft transparent plastic sandwich is also easy to deal with the problem of uneven thickness, which further reduces the production cost.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1A is a cross sectional view of a conventional laminated glass;

FIG. 1B is a cross sectional view of another conventional laminated glass;

FIG. 2 is a flow chart showing the steps of the method for manufacturing a laminated glass with an inserted film in accordance with a preferred embodiment of the invention;

FIG. 3A is an illustrative view of the invention showing that the first soft transparent plastic layer is formed with a receiving hole;

FIG. 3B is an illustrative view of the invention showing that the first soft transparent plastic layer is placed on the first layer of glass, and then the soft transparent plastic sandwich and the second layer of glass are placed sequentially; and

FIG. 3C is an illustrative view of the invention showing that the first layer of glass, the first soft transparent plastic layer, the soft transparent plastic sandwich and the second layer of glass are bonded together to form the laminated glass.

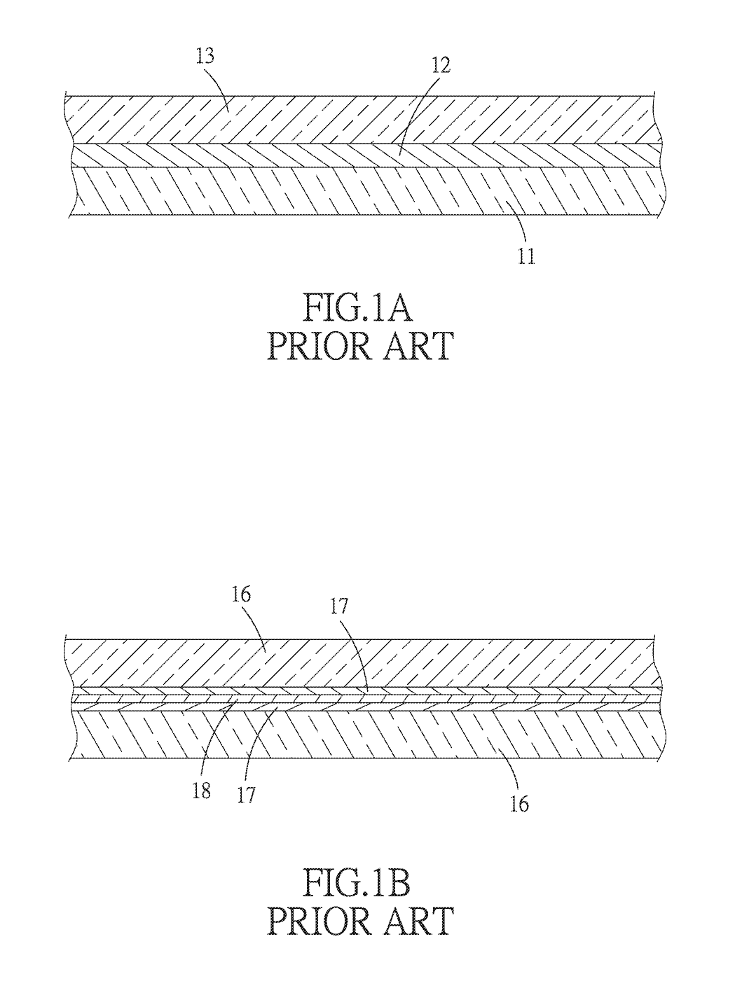

### DETAILED DESCRIPTION

The present invention will be clearer from the following description when viewed together with the accompanying drawings, which show, for purpose of illustrations only, the preferred embodiment in accordance with the present invention.

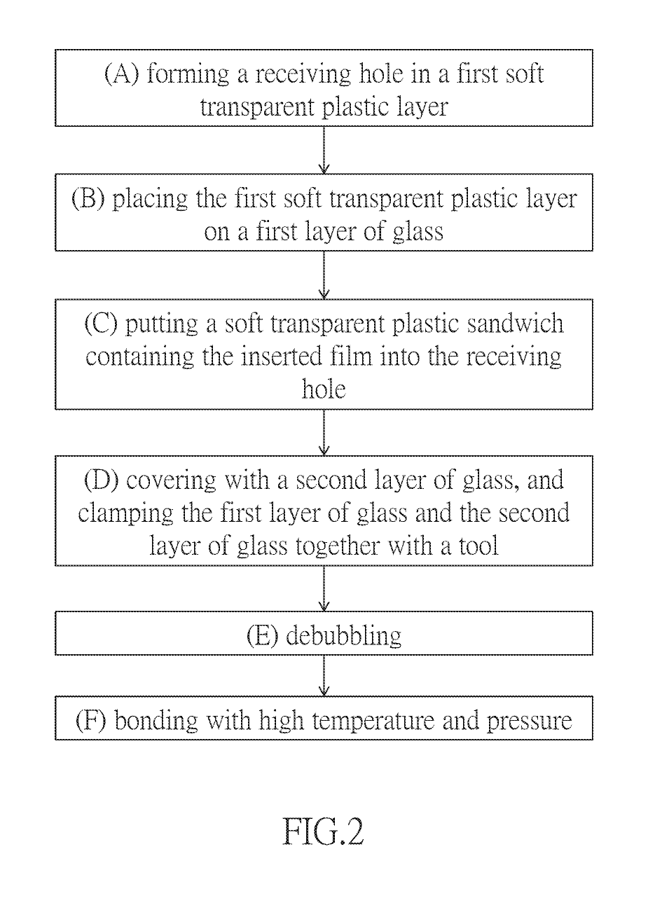

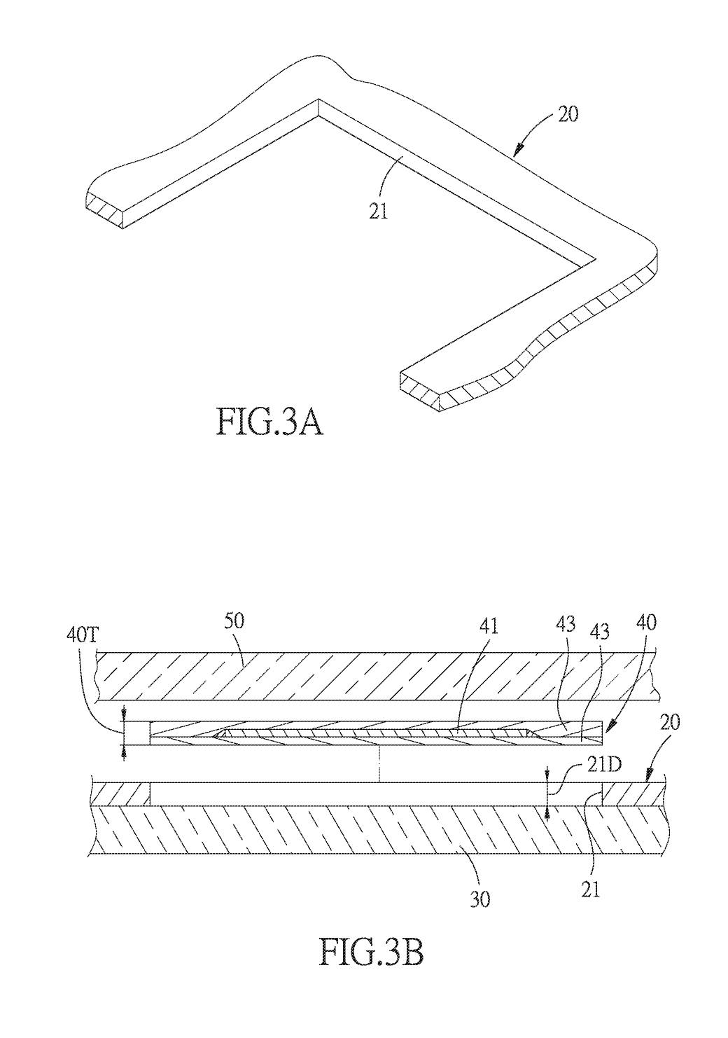

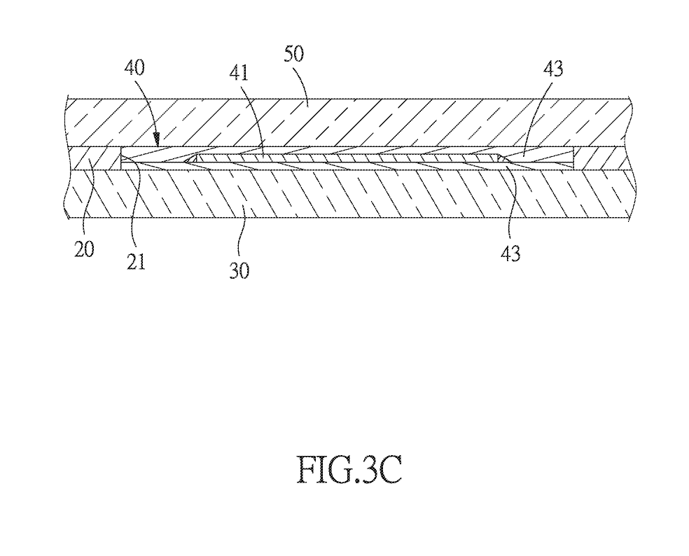

Referring to FIGS. 2 and 3A-3C, a method for manufacturing a laminated glass with an inserted film in accordance with the preferred embodiment of the invention comprises the followings steps:

As shown in FIGS. 2 and 3A, a step A of forming a receiving hole 21 in a first soft transparent plastic layer 20; in this embodiment, the first soft transparent plastic layer 20 is PVB (Polyvinyl butyral), and the receiving hole 21 is rectangular-shaped and can be formed by cutting away a portion of the first soft transparent plastic layer 20;

a step B of placing the first soft transparent plastic layer 20 on a first layer of glass 30, as shown in FIGS. 2 and 3B; in this embodiment, the first soft transparent plastic layer 20 is pulled flat and moved to adjust the receiving hole 21 to an appropriate position;

a step C of putting a soft transparent plastic sandwich 40 containing the inserted film 41 into the receiving hole 21, as shown in FIGS. 2 and 3B; wherein the soft transparent plastic sandwich 40 has a thickness 40T equal to or smaller than a depth 21D of the receiving hole 21; in this embodiment, the soft transparent plastic sandwich 40 is formed by inserting the inserted film 41 between two second soft transparent plastic layers 43 which are made of PVB, and the inserted film 41 is a reflection layer to provide a reflection surface;

a step D of covering with a second layer of glass 50, and clamping the first layer of glass 30 and the second layer of glass 50 with a tool, as shown in FIGS. 2, 3B and 3C; a step E debubbling; and a step F bonding with high temperature and pressure. The steps E and F are respectively used to perform a first stage of heating slightly under pressure to remove residual bubbles, and then perform a bonding process at higher temperature under higher pressure to adhere the first and second layers of glass 30, 50 to the first soft transparent plastic layer 20 containing the soft transparent plastic sandwich 40.

What mentioned above is the description of the respective steps of the method of the invention, and the efficacy of the invention is described as follows:

The invention adopts the method of processing the film locally, wherein a small piece of soft transparent plastic sandwich 40 containing the inserted film 41 is manufactured in advance, that is, the inserted film 41 is processed in the small area of the soft transparent plastic sandwich 40 to deal with the total thickness difference, so as to produce the soft transparent plastic sandwich 40 which has a thickness equal to or smaller than the thickness of the first soft transparent plastic layer 20 of the laminated glass. Before the first and second layers of glass 30, 50 are bonded, the first soft transparent plastic layer 20 is partially cut away to form the receiving hole 21 which has the same area as the soft transparent plastic sandwich 40. After the first layer of glass 30 is placed on the first soft transparent plastic layer 20 with the receiving hole 21, the soft transparent plastic sandwich 40 is put into the receiving hole 21 of the first soft transparent plastic layer 20 and heated under pressure, so that the soft transparent plastic sandwich 40 is welded seamlessly with the peripheral first soft transparent plastic layer 20 at high temperature. Accordingly, the present invention has at least the following efficacy.

Effectively reduce the production cost. The method for manufacturing a laminated glass with inserted films in accordance with the invention is capable of inserting film in a small area instead of in a large area of the laminated glass, namely, the inserted film 41 is firstly inserted in the small soft transparent plastic sandwich 40, so as to reduce the production cost. Meanwhile, the residual air bubbles which will influence the yield rate are processed in the soft transparent plastic sandwich 40, even if bubbles occur, the defective product will only be the soft transparent plastic sandwich 40 instead of the whole laminated glass, so that the production cost is effectively reduced. Besides, the small size soft transparent plastic sandwich 40 is also easy to deal with the problem of uneven thickness, which further reduces the production cost.

While we have shown and described various embodiments in accordance with the present invention, it is clear to those skilled in the art that further embodiments may be made without departing from the scope of the present invention.

What is claimed is:

1. A method for manufacturing a laminated glass with an inserted film, comprising the followings steps:
a step A of forming a receiving hole in a first soft transparent plastic layer;
a step B of placing the first soft transparent plastic layer on a first layer of glass;
a step C of putting a soft transparent plastic sandwich containing the inserted film into the receiving hole, wherein the soft transparent plastic sandwich has a thickness equal to or smaller than a depth of the receiving hole;
a step D of covering with a second layer of glass, and clamping the first layer of glass and the second layer of glass together with a tool;
a step E debubbling; and
a step F bonding with high temperature and pressure.

2. The method as claimed in claim 1, wherein after the step B, the first soft transparent plastic layer is pulled flat and the receiving hole is adjusted to an appropriate position.

3. The method as claimed in claim 1, wherein the soft transparent plastic sandwich is formed by inserting the inserted film between two second soft transparent plastic layers.

4. The method as claimed in claim 3, wherein the two second soft transparent plastic layers are made of polyvinyl butyral.

5. The method as claimed in claim 1, wherein the inserted film is made of cyclic olefin polymer.

6. The method as claimed in claim 1, wherein the first soft transparent plastic layer is made of polyvinyl butyral.

7. The method as claimed in claim 1, wherein the inserted film is a reflection layer to provide a reflection surface.
